(19) United States
(12) Patent Application Publication
(10) Pub. No.: US 2025/0207790 A1
(43) Pub. Date: Jun. 26, 2025

(54) SYSTEMS AND METHODS FOR CONTROLLING AND TREATING GAS STREAMS

(71) Applicants: Ross BONNER, Salem, MA (US); Transaera, Inc., Somerville, MA (US)

(72) Inventors: Ross Bonner, Salem, MA (US); Matthew H. Dorson, Arlington, MA (US); Sorin Grama, Somerville, MA (US)

(73) Assignee: Transaera, Inc., Somerville, MA (US)

(21) Appl. No.: 18/848,102

(22) PCT Filed: Mar. 31, 2023
(86) PCT No.: PCT/US2023/017218

§ 371 Date: Sep. 17, 2024

Related U.S. Application Data
(60) Provisional application No. 63/437,601, filed on Jan. 6, 2023.
(60) Provisional application No. 63/326,254, filed on Mar. 31, 2022.

(51) Int. Cl. F24F 3/14; B01D 53/04; B01D 53/26

(52) U.S. Cl. CPC F24F 3/1411; B01D 53/0438; B01D 53/0454; B01D 53/261; B01D 2257/80; B01D 2258/06; B01D 2259/40003; B01D 2259/40088; B01D 2259/402; B01D 2259/4508

(57) ABSTRACT

A system is provided for affecting temperature (cooling and/or heating) and/or the presence of an adsorbable species (e.g., water, through humification and/or dehumidification) in a gaseous environment. The system includes at least one heat and/or mass transfer device which can be in thermal contact with an adsorbent, such as a desiccant. The system can include multiple heat and/or mass transfer devices that cycle through modes, often different modes one from the other at a given time, and can include one more compressor(s)/evaporator(s) containing a refrigerant, an expansion device, control valves and/or other suitable equipment. The system can be used to condition a gaseous environment, such as by air conditioning, heating, dehumidification, humidification, or any of these alone or in combination. Gas flow-directing valve assemblies, and related methods, are also provided.

### RELATED APPLICATIONS

This application claims priority to U.S. Provisional Application No. 63/326,254, filed Mar. 31, 2022, and to U.S. Provisional Application No. 63/437,601, filed Jan. 6, 2023, both of which are incorporated herein by reference in their entirety.

### TECHNICAL FIELD

The present invention relates systems and methods for managing the treatment of gas flows, including valve assemblies to direct the flow of a gas, controllers for managing gas flow systems, including but not limited to application in heating, cooling, and/or changing the composition of air.

### BACKGROUND

Managing the flow and/or treatment of gasses is important in many devices, systems, and methods, including but not limited to heating, air conditioning and/or humidification or dehumidification systems. Gas flow control is typically complex, involving multiple valves and pathways and a significant amount of equipment and/or volume of gas conduits through such systems, valves, etc.

Air conditioning systems account for a significant amount of global energy usage, and thus more energy efficient methods for conditioning air are desirable. Accordingly, improved systems and methods for controlling the flow of gas and conditioning air in an energy efficient manner are needed.

### SUMMARY

The present disclosure involves a series of gas control or handling systems, devices, valves assemblies, and methods as set forth in the claims near the end of this disclosure. The subject matter of the present disclosure involves, in some cases, interrelated products, alternative solutions to a particular problem, and/or a plurality of different uses of one or more systems and/or articles.

Some aspects are related to systems. In some embodiments, the system comprises a heat pump, comprising at least a first heat and/or mass transfer device, and an adsorbent in thermal communication therewith, configured to adsorb and/or desorb a species from a gas exposed thereto, and a controller configured to set the heat pump in a first mode in which the adsorbent is adsorbing a species, and to switch the heat pump from the first mode to a second mode in which the adsorbent is desorbing a species, wherein the controller is configured to substantially change at least one heat pump condition during the first mode and/or the second mode.

Another aspect is related to methods. In some embodiments, the method of operating a heat pump comprises detecting an absolute humidity ratio, and switching the heat pump from a first mode in which at least a first heat and/or mass transfer device is loaded and at least a second heat and/or mass transfer device is unloaded to a second mode in which the first heat and/or mass transfer device is unloaded and the second heat and/or mass transfer device is loaded.

In some cases, the method of operating a heat pump comprises setting the heat pump in a first mode in which at least a first heat and/or mass transfer device is loaded and at least a second heat and/or mass transfer device is unloaded, substantially changing at least one heat pump condition during the first mode, and switching the heat pump from the first mode to a second mode in which the first heat and/or mass transfer device is unloaded and the second heat and/or mass transfer device is loaded.

In another aspect, the gas handling system comprises a valve assembly housing, comprising at least first, second, third, and fourth gas ports, each configured to receive an inlet gas stream into the housing or to deliver an outlet gas stream from the housing, a heat and/or mass transfer device, configured to allow heat and/or mass transfer with a gas in an inlet gas stream or an outlet gas stream, a valve assembly configured to (a) establish fluid communication between the first gas port and the second gas port, while inhibiting fluid communication between the first gas port and the third and fourth gas ports, or (b) establish fluid communication between the first gas port and the second and third gas ports, while inhibiting fluid communication between the first gas port and the fourth gas port.

In some aspects, the method of affecting gas flow comprises flowing a first gas stream from a first gas inlet port through a common gas flow space and out a first gas outlet port while flowing a second gas stream from a second gas inlet port through the common gas flow space and out a second gas outlet port, and flowing the first gas stream from the first gas inlet port through the common gas flow space and out the second gas outlet port while flowing the second gas stream from the second gas inlet port through the common gas flow space and out the first gas outlet port, while conditioning one of the gas streams.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A depicts a cooling and dehumidification system with two desiccant coated passive heat transfer devices in a first mode of operation, according to some embodiments;

FIG. 1B depicts a cooling and dehumidification system with two desiccant coated passive heat transfer devices in a second mode of operation, according to some embodiments;

FIG. 2 is a cross section illustration of a system comprising an air directing valve, according to some embodiments;

FIG. 3A-B are diagrams of system comprising an air directing valve, according to some embodiments;

FIG. 4 is a graph depicting power consumption versus time of a conventional system of the prior art and the present system; and

FIG. 5 is a block diagram of a system controller, according to some embodiments.

### DETAILED DESCRIPTION

The present disclosure provides a series of gas handling systems, gas flow directing devices, valve assemblies, and other systems and methods for use in controlling or affecting the flow and/or conditioning of a gas. A variety of gases can be controlled and/or affected by aspects and embodiments of the invention as will be understood by those of ordinary skill in the art. This disclosure demonstrates various embodiments that use the control of flow and/or conditioning of air (e.g., ambient air), but it is to be understood that other gases can, of course, be used.

Described below are a variety of such arrangements and methods, in various embodiments. It is to be understood that any individual arrangement described below can be used with any other arrangement or method of the disclosure. Not all possible combinations are specifically described, because those of ordinary skill in the art will clearly understand, from this disclosure, the ability to make such combinations and advantages in doing so. Yet as an example of certain combinations it is to be understood that in any arrangement or method described in this disclosure, an adsorbent or a number of adsorbents can be used, but may not be used. Where heating and/or cooling is disclosed or would be apparent, this can be done via compression and/or expansion of a refrigerant as in a typical air conditioning system, and/or via flow of a fluid that is heated or cooled other than by expansion or compression, electric resistance/coil heating, heating through fossil fuel combustion or solar energy, cooling of a chilled fluid in a separated device provided by a chiller, or the like. Where a single heat and/or mass transfer device is described, it is to be understood that any number of such devices can be employed, in series and/or parallel, associated with any port or air flow stream described in any device or method herein. Where multiple heat and/or mass transfer devices are described, it is to be understood that less than the number described can be used, including just one such device or no device.

In one aspect, this disclosure provides a gas handling system including a valve assembly with a number of gas ports interconnected with each other as part of a valve assembly housing, and a valve assembly configured to establish and/or inhibit fluid communication between and among any number of ports. For example, in some cases, there may be a first inlet, a second inlet, a first outlet, and a second outlet, all in fluid communication with the valve. The valve may be arranged to fluidically connect the first inlet and the first outlet, to fluidically connect the second inlet and the second outlet, while isolating the two flow paths, in some embodiments. According to some cases, the valve may be arranged to fluidically connect the first inlet and the second outlet while separately fluidically connecting the second inlet and the first outlet. Other arrangements are possible, for example, where the first inlet, the second inlet, and the first outlet are fluidically connected, where the second outlet is fluidly isolated. In some cases, the first inlet, the second inlet, and the second outlet are fluidically connected, where the first outlet is fluidly isolated. In some embodiments, the first inlet, the first outlet, and the second outlet are fluidically connected, where the second inlet is fluidly isolated. In some cases, second inlet, the first outlet, and the second outlet are fluidically connected, where the first inlet is fluidly isolated.

Some aspects of the present disclosure are directed to control systems for controlling operation of a valve assembly. In some cases, the valve may be integrated within an air conditioning system, designed for heating, cooling, and/or changing the composition of at least one air stream. According to some embodiments, the air conditioning system may further comprise heat and/or mass transfer devices. In some embodiments, the system may be switched between the first mode and a second mode, e.g., where the first mode is such that the valve is in a first arrangement and the second mode is such that the valve is in a second arrangement. When switching between modes, in some cases, the function of the heat/or mass transfer devices may switch, for example, between adsorbing and/or desorbing a species. The controlling system of the present disclosure may be advantageous when compared to conventional control systems because it may control and alter system parameters (e.g., compressor speed, position of expansion valve, and/or speeds of fans) during each mode of operation to improve energy efficiency of the system, as described in more detail elsewhere herein.

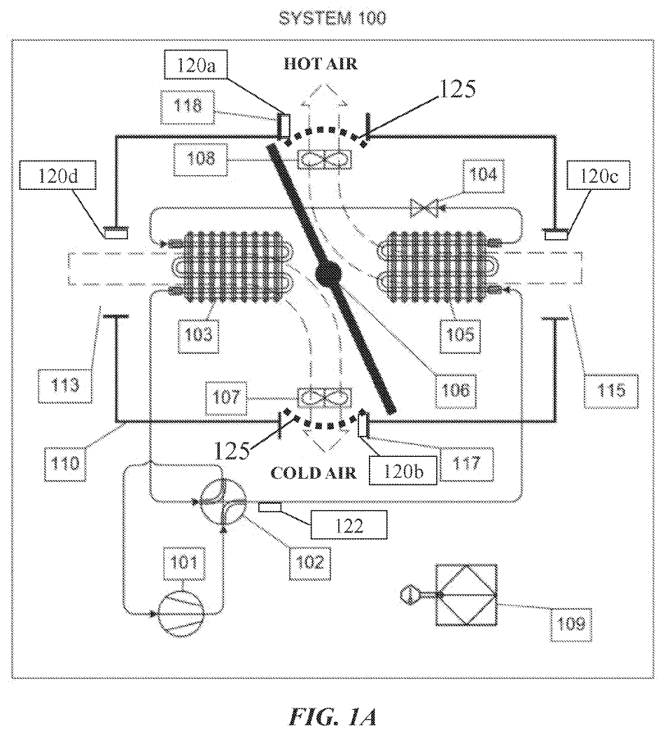

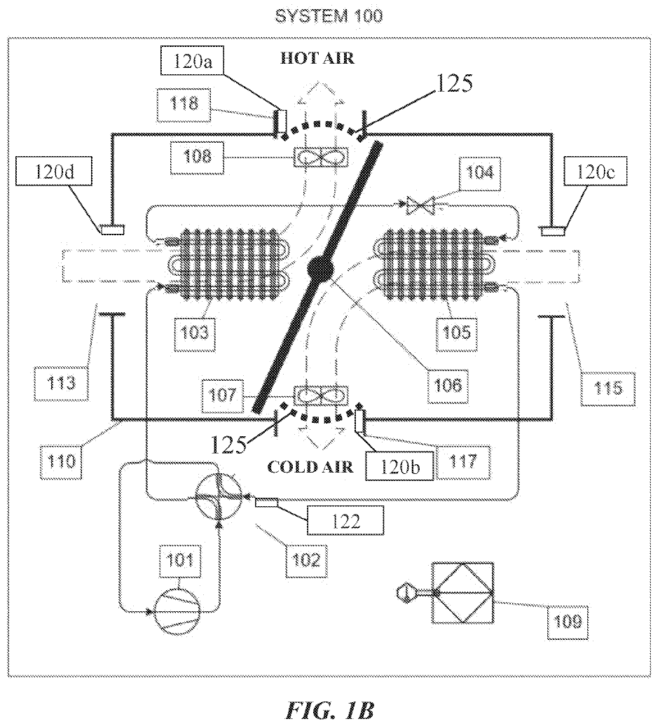

For example, referring to FIGS. 1A and 1B, a generalized arrangement of one aspect of the invention is illustrated schematically. FIGS. 1A-1B show schematic views of an exemplary system 100 for conditioning air via heating, cooling, and/or changing the composition of the gas stream. In operation, the system 100 cycles between two modes of operation: a first mode in which the first desiccant and/or adsorbent coated heat and/or mass transfer device 103 is loaded (e.g., a species is adsorbed) and the second desiccant and/or adsorbent coated heat and/or mass transfer device 105 is unloaded (e.g., a species is desorbed), and a second mode in which the first desiccant and/or adsorbent coated heat and/or mass transfer device 103 is unloaded and the second desiccant and/or adsorbent coated heat and/or mass transfer device 105 is loaded. Wherever “load” or “loaded” is used herein, it is to be understood this can mean that an adsorbent adsorbs a species, and when “unload” or “unloaded” is used, it is to be understood this can mean that an adsorbent desorbs a species.

The system 100 comprises a first inlet 113 (e.g., an air duct), a second inlet 115, a first outlet (e.g., an air duct) 117, and a second outlet 118. Each of the first and second inlets can be configured for connection to a source of a gas stream. In the arrangement illustrated, each inlet and outlet is connected via a port associated with a valve assembly. The valve assembly may be located within a housing, e.g., a valve assembly housing. The valve assembly housing and/or the valve assembly may comprise at least one, at least two, at least, three, or at least four gas ports. Typically, a port is an opening between regions of a gas flow controller. For example, where housings are shown and described in figures herein, and connect to incoming or outcoming airstreams, those connections occur at ports. A port allows the flow of a gas from one region to another. As shown, the first port can be a first inlet configured for connection to a first source of a first gas stream and the second port can be an inlet configured for connection to a different, second source of a second gas stream. In one set of embodiments the first and second inlets can be connected to a common or single source, for example where the first and second gas streams originate from a common source. Each of the first and second gas inlets is fluidly connectable to either of the first or second gas outlets, and this independent connectability can traverse the interior of the device, as illustrated in FIGS. 1A-1B.

In one set of embodiments, system 100 includes a valve having a baffle or other similar component 106 configured to affect the flow of gas, wherein fluid connection between different ports (e.g., inlets and/or outlets) may be established and/or altered based on the valve being switchable between a number of positions. In some cases, there may be a single, integral baffle. As disclosed later herein, some valves comprise multiple, independently addressable baffles. FIG. 1A illustrates a first position of valve baffle 106 in which the first inlet 113 is in fluid communication with the first outlet 117 and the second inlet 115 is in fluid communication with the second outlet 118. FIG. 1B illustrates a second position of valve baffle 106 in which the first inlet 113 is in fluid communication with the second outlet 118 and the second inlet 115 is in fluid communication with the first outlet 117.

Although not always the case, in the embodiments illustrated, in the first position of baffle 106 as shown in FIG. 1A, fluid connection between the first inlet 113 and the second outlet 118 is inhibited, and fluid connection between the second inlet 115 and the first outlet 117 is inhibited. “Inhibited,” in this context, can involve at least some degree of resistance to flow that is greater than the resistance to flow experienced by a gas traversing inlets and outlets that are fluidly connected. In one set of environments, “inhibited” can mean that gas flow is essentially entirely prevented between an inlet and an outlet where the valve is set to inhibit flow between those two ports. Those of ordinary skill in the art will understand that inhibited flow can mean partial (e.g., greater than 60%, greater than 70% greater than 80% greater than 90% of the flow path is blocked, relative to when the flow path is open in for example FIG. 1B), or essentially complete prevention of gas flow as controlled by the baffle setting of the valve (e.g., partially or fully closed), and/or the degree of sealing (partial, near-full, or essentially full sealing) where the baffle fits against a seating surface of the valve in the closed position, etc.

Flow inhibition may be measured by any suitable method. In some cases, the amount of inhibition may be determined by the change in the smallest cross-sectional area of the flow path. That is, the gas stream flows along a flow path. In some cases, the flow path may be uniform and in other cases the flow path may be non-uniform (e.g., constricted at some point). The cross-section of the flow path with the smallest cross-sectional area, in some cases, may be obtained at any location of the flow path, for example, if the flow path is uniform. According to some embodiments, the flow path may have a portion where the cross-sectional area is smallest, for example, when a valve is partially or completely shut. Cross-sectional area typically is aligned with the area of a gas flow space taken normal, or perpendicular, to the general or mean direction of gas flow.

For example, in some cases, the smallest cross-sectional area of the flow path of a gas stream between and inlet and an outlet through the system may be greater than or equal to 1 cm², greater than or equal to 5 cm², greater than or equal to 10 cm², greater than or equal to 15 cm², greater than or equal to 20 cm², greater than or equal to 30 cm², greater than or equal to 40 cm², greater than or equal to 50 cm², greater than or equal to 1 m², greater than or equal to 2 m², greater than or equal to 3 m², greater than or equal to 4 m², or greater than or equal to 5 m² when the flow path is not inhibited. In some embodiments, when the flow path is not inhibited, the smallest cross-sectional area of the flow path of a gas stream between an inlet and an outlet through the system may less than or equal to 5 m², less than or equal to 4 m², less than or equal to 3 m², less than or equal to 2 m², less than or equal to 1 m², less than or equal to 50 cm², less than or equal to 40 cm², less than or equal to 40 cm², less than or equal to 30 cm², less than or equal to 20 cm², less than or equal to 10 cm², less than or equal to 5 cm², or less than or equal to 1 cm². Combinations of the foregoing ranges are possible. In some cases, the smallest cross-sectional area of the flow path of a gas stream may be at least 5%, at least 10%, at least 20%, at least 30%, at least 50%, at least 70%, at least 80%, at least 90%, or 100% of the cross-sectional area of the smaller of the cross-sectional areas of the inlet port and the outlet port when the gas stream is not inhibited.

In contrast, when the flow path is inhibited, the smallest cross-sectional area of the flow path of a gas stream between and inlet and an outlet through the system may be greater than or equal to 1 micron², greater than or equal to 10 microns², greater than or equal to 100 microns², greater than or equal to 500 microns², greater than or equal to 1 mm², greater than or equal to 2 mm², greater than or equal to 5 mm², greater than or equal to 1 cm², greater than or equal to 10 cm², greater than or equal to 50 cm², greater than or equal to 100 cm², or greater than or equal to 250 cm². In some cases, when the flow path is inhibited, the smallest cross-sectional of the flow path of a gas stream between an inlet and an outlet through the system may be less than or equal to 500 cm², less than or equal to 250 cm², less than or equal to 100 cm², less than or equal to 50 cm², less than or equal to 10 cm², less than or equal to 1 cm², less than or equal to 5 mm², less than or equal to 2 mm², less than or equal to 1 mm², less than or equal to 500 microns², less than or equal to 100 microns², less than or equal to 10 microns², or less than or equal to 1 micron². Combinations of the foregoing ranges are possible. In some cases, the smallest cross-sectional area of the flow path of a gas stream may be less than 40%, less than 30% less than 20%, less than 15%, less than 10%, less than 5%, less than 1%, or less of the of the cross-sectional area of the smaller of the cross-sectional areas of the inlet port and the outlet port when the gas stream is inhibited.

Alternatively, to determine the amount of inhibition between an inlet and outlet, those of ordinary skill in the art may measure a change in gas flow rate between and inlet and an outlet, when flowing a gas stream at a constant volumetric flow rate through the inlet. In some cases, when the gas stream is not inhibited, the flow rate at the outlet may be approximately (e.g., within 10%, within 5%, within 2%, or within 1%) equal to the flow rate at the inlet. In cases where the gas stream is inhibited (e.g., by the valve), the gas flow rate at the outlet may be substantially lower than the flow rate at the inlet. In some cases, the flow rate at the outlet may be greater than or equal to 10%, greater than or equal to 25%, greater than or equal to 50%, greater than or equal to 75%, or greater than or equal to 90% less than the flow rate at the inlet.

Depending upon how system 100 is built and configured, in one set of embodiments it facilitates a more efficient use of overall internal gas flow volume, and/or overall space the valve takes in combination with other components in an overall system in which it resides. This is in part because of common gas flow space within the valve which is at least in part shared by different gas flow pathways, through the valve, depending upon the position of baffle 106. To illustrate just one example of many, in FIG. 1A a gas flow pathway can be seen to pass through a portion of the valve from inlet to 113 to outlet 117. In FIG. 1B, it can be seen that a second gas flow pathway from inlet 113 to outlet 118 passes through at least a portion of the valve that is common to the portion through which the first gas flow pathway of FIG. 1A passes. As can be seen, in the valve embodiment illustrated in FIGS. 1A and 1B, essentially all of the common gas flow space serves different gas flow pathways, depending upon the position of baffle 106. In other embodiments (e.g., not illustrated in FIGS. 1A and 1B), a smaller portion of the total volume connecting different inlets and outlets serves, at one time/valve setting or another, as common gas flow space. For example, in other embodiments, at least 10%, 25%, 50%, or 75% of the valve space connecting inlets and outlets serves as common gas flow space. In the embodiment illustrated in FIGS. 1A and 1B, the common gas flow space can be seen to be the volume through which baffle 106 rotates (with boundaries illustrated by dotted lines 125), and bounded by the junction between outlet 117 and the interior of the valve, and outlet 118 and the interior of the valve. In another set of embodiments, the common gas flow space can be defined as that volume which serves, at least at one time or another depending upon the position of baffle 106 or other baffles, to conduct different gas flow streams.

In one set of embodiments, a heat and/or mass transfer devices 103 and 105 are provided in combination with system 100 associated with valve 106 (e.g., associated with the valve 106 or associated with one or more conduits in fluid communication with an inlet 113 or 115 or outlet 117 or 118 of the valve, or multiple inlets and/or outlets. In another set of embodiments, an adsorbent can be associated with the valve and/or conduits/inlets/outlets.

Heat and/or mass transfer devices are equivalent to heat and/or mass transfer elements, these terms being used interchangeable in the present disclosure. Heat and/or mass transfer devices are known to those skilled in the art.

Heat transfer devices used in connection with the present disclosure typically include devices capable of transferring heat from a source at one temperature to a sink at a lower temperature. In one set of embodiments, a heat transfer device is a condenser that condenses a gas (typically by pressurizing the refrigerant that can be a gas or liquid, and changes state during condensation and evaporation conditions under higher or lower pressure, relatively) which transfers heat from hot refrigerant to a gas at a lower temperature and an evaporator transfers heat from a gas at a higher temperature to refrigerant at a lower temperature. Mass transfer devices typical of use with the systems and methods of this disclosure generally transfer mass of some species from a source at higher concentration to a sink at lower concentration. For example, a mass transfer device may include an adsorbent composition which adsorbs and desorbs a species, transferring mass to, and away from, the adsorbent, respectively. E.g., a desiccant which effects mass transfer of water vapor from the air at high concentration to the desiccant at low concentration of adsorbed water, and desorbs via mass transfer of water vapor from the desiccant at high concentration of adsorbed water to air at a low concentration of water vapor.

Nonlimiting examples of heat and/or mass transfer devices include heat coils, natural gas, refrigerant, Peltier coolers, adsorbents, and desiccants. The heat and/or mass transfer device may be in thermal communication with an air stream, according to some embodiments. Being in thermal communication indicates that the heat and/or mass transfer device is able to conduct heat to and/or from the air stream, e.g., via direct physical contact or through another material such as a pipe made of relatively thermally conductive material like copper. Thermal communication can involve allowing conductive heat transfer between bodies or surfaces, optionally with auxiliary structures, layers, and/or materials between such bodies or surfaces so long as intervening structures allow sufficient thermal communication. In some embodiments, articles or surfaces in thermal communication with each other have sufficient thermal communications such that a temperature gradient between them (including thermal passage/conduction through any intervening layers or materials) will be no more than 10, 6, 3, or 1 degree Celsius.

In one set of embodiments, a heat and/or mass transfer device includes a heat exchanger in thermal communication with an adsorbent (which can be a desiccant). Examples of suitable heat exchangers include a tube-fin type heat exchanger and/or microchannel type heat exchanger. Other types of heat exchangers can be used in systems and methods of this disclosure.

In some cases, as shown in system 100 in FIGS. 1A-B, a heat pump is configured to move heat energy between a plurality of heat and/or mass transfer devices. The heat pump can include a compressor 101, refrigerant reversing valve 102 for reversing a direction of refrigerant in the system, a first desiccant and/or adsorbent coated (e.g., partially coated or completed coated) heat and/or mass transfer device 103, expansion valve 104 for controlling refrigerant flow, and a second desiccant and/or adsorbent coated (e.g., partially coated or completely coated) heat and/or mass transfer device 105. System 100 further includes an air-tight enclosure 110, at least one air directing valve 106, fan 107 directing cold air flow through duct 117, fan 108 directing hot air flow through duct 118 and system controller 109 connected (wired or wirelessly) to a plurality of sensors measuring parameters such as temperature (indoor and/or outdoor), humidity (indoor and/or outdoor), current consumption of one or more modules or submodules of the system 100 (such as compressor 101), voltage of one or more modules or submodules of the system 100 (such as compressor 101), or refrigerant pressure that represent the state of the system and the indoor and outdoor conditions.

The foregoing is intended as a non-limiting example to illustrate one possible combination and configuration of elements. While the elements shown in FIGS. 1A-B work in unity to condition air in the configurations shown, it is to be understood that other configurations, as well as the removal or addition of other elements are possible in other embodiments. For example, in some cases, the system may not comprise the sensors at every inlet and/or outlet as shown in FIGS. 1A-B. In some embodiments, other combinations and configurations of elements are possible.

In the first mode, the at least one air directing valve 106 is set to a first position as shown in FIG. 1A in which air passes through the first inlet (e.g., an air duct) 113, across the first desiccant and/or adsorbent coated heat and/or mass transfer device 103, and through the first outlet (e.g., an air duct) 117. The at least one air directing valve 106 also directs air passing through the second inlet (e.g., an air duct) 115 across the second desiccant and/or adsorbent coated heat and/or mass transfer device 105, and through the second outlet (e.g., an air duct) 118. In the first mode, refrigerant passes from the second desiccant and/or adsorbent coated heat and/or mass transfer device 105 to the first desiccant and/or adsorbent coated heat and/or mass transfer device 103 via expansion valve 104 and refrigerant passes from the first desiccant and/or adsorbent coated heat and/or mass transfer device 103 to the second desiccant and/or adsorbent coated heat and/or mass transfer device 105 via valve 102, passing through compressor 101. In this mode, the first desiccant and/or adsorbent coated heat and/or mass transfer device 103 is loaded (e.g., moisture and/or another species is adsorbed) and the second desiccant coated passive heat transfer device 105 is unloaded (e.g., moisture and/or another species is desorbed). Note that the terms loaded and unloaded are used interchangeably with the terms adsorbed and desorbed, respectively, throughout the present disclosure. While various embodiments of the present disclosure are directed to systems wherein the adsorbent is adsorbing water, when referencing the terms loaded, unloaded, adsorbed, or desorbed, it is to be understood that the terms may be generalized to any species being adsorbed/desorbed to an adsorbent, as described in more detail elsewhere herein.

In a second mode, the at least one air directing valve 106 is set to a second position as shown in FIG. 1B. Here, refrigerant flows in the opposite direction as in FIG. 1A, passing from the first desiccant and/or adsorbent coated heat and/or mass transfer device 103 to the second desiccant and/or adsorbent coated heat and/or mass transfer device 105 via expansion valve 104 and refrigerant passes from the second desiccant and/or adsorbent coated heat and/or mass transfer device 105 to the first desiccant and/or adsorbent coated heat and/or mass transfer device 103 via valve 102, passing through compressor 101. In this mode, first desiccant coated passive heat transfer device 103 is unloaded (e.g., moisture is desorbed) and the second desiccant coated passive heat transfer device 105 is loaded (e.g., moisture is adsorbed).

System 100 can also operate in heat pump mode whereby the cold and hot air discharge are swapped such that fan 107 directs hot air flow through duct 117 while fan 108 directs cold air flow through air discharge duct 118. In this example, the valve 106 may be switched from the first position to the second position, but the valve 102 will remain fixed. Methods of controlling the heating, cooling and dehumidification system as described in the examples above can be implemented by system controller 109 using a process (or) and a non-transitory storage medium (e.g., memory) having instructions stored thereon and configured to be executed by the processor.

The system controller 109 can be instantiated in a computing device of any kind, such as a desktop computer, laptop computer, tablet, mobile device, embedded microcontroller, programmable logic controller, etc. In this regard, the system controller 109 can be associated with a display, can receive user input, and/or can be connected to other computing systems (e.g., a server) via a wired or wireless connection, for example, a direct user interface like a thermostat, humidistat, and/or building controller. In one example, the system controller can be a smart home system configured to control one or more aspects of home operation, such as lights, heating/cooling operation, etc. In this regard, the system controller can access weather forecasts and adjust operation based thereon. Further details about the controller are discussed elsewhere herein.

A significant control logic decision affecting the performance of the system is the decision of switching from the first position/mode (FIG. 1A) to the second position/mode (FIG. 1B) thereby maintaining an optimal moisture and/or species removal rate for the given desiccant and/or adsorbent material.

The process of switching involves one or more coordinated actions. These actions may include switching air directing valve 106 from a first position (depicted in FIG. 1A) to a second position (depicted in FIG. 1B), reversing refrigerant flow using refrigerant reversing valve 102 (from the direction in FIG. 1A to the direction in FIG. 1B or vice versa), changing compressor 101 speed, adjusting position of expansion valve 104 from fully closed to fully open or changing the speeds of fans 108 and 107. The system 100 can implement one or more methods or techniques in order to switch the system 100 from the first position/mode to the second position/mode and/or from the second position/mode to the first position/mode or to optimize the operation of the system before, during, or after a switch. Such methods or techniques are described elsewhere herein. While several methods or techniques are described below, it is understood that each method or technique can be implemented independently from other techniques, and that system 100 can implement one, all, or any subcombination of the methods or techniques described elsewhere herein.

As shown, sensor 120a can be positioned at or in proximity to duct 118 for measuring one or more parameters of an airstream passing through the duct 118, such as temperature or humidity. Similarly, sensor 120b can be positioned at or in proximity to duct 117 for measuring one or more parameters of an airstream passing through the duct 117, such as temperature or humidity. Similarly, sensor 120c can be positioned at or in proximity to duct 115 for measuring one or more parameters of an airstream passing through the duct 115, such as temperature or humidity. Similarly, sensor 120d can be positioned at or in proximity to duct 113 for measuring one or more parameters of an airstream passing through the duct 113, such as temperature or humidity. While four sensors 120a-d are depicted, system can incorporate one, all, or any subcombination of the depicted sensors. In one specific example, sensors 120c-d are omitted and only sensors 120a-b are incorporated. Multiple sensors may be positioned and used in tandem at a single gas port. For example, a temperature sensor and humidity sensor may be positioned at an inlet or outlet, which may be advantageous for measuring a humidity ratio, which is calculated using both temperature and humidity.

Additionally, as also shown in FIG. 1A, sensor 122 can be positioned at or in proximity to refrigerant reversing valve 102 for measuring one or more parameters of refrigerant passing through the valve(s), such as temperature and/or pressure. While sensor 122 is depicted at or in proximity to refrigerant reversing valve 102, sensor 122 can be positioned at any valve orientation or location in the system 100 where refrigerant passes. Sensors positioned and configured to measure properties related to the refrigerant may be useful in monitoring and/or controlling when to change parameters of the system (e.g., changing compressor speed, adjusting position of expansion valve from fully closed to fully open, and/or changing the speeds of fans) when switching modes and/or during different phases of a single mode, as described in more detail elsewhere herein.

As noted, inlets 113 and 115 can be connected to a common source of a gas or different sources (of different gases or the same gas), or a mixture. In one set of embodiments, where valve 106 is used in a system for conditioning air, inlets 113 and 115 can draw air from an indoor space, an outdoor space, or air blended between indoor and outdoor space. In one sub embodiment, inlets 113 and 115 both draw air from indoor space, and in another sub embodiment both inlets 113 and 115 draw air from outdoor space. In either of these arrangements the inlets can be connected to different conduits that each draw from indoor or outdoor space, or can be connected to a single conduit that draws air from those spaces. “Indoor” and “outdoor” are given their common and ordinary meaning in the field of conditioning air in this regard. “Conditioning air,” as used herein, can mean any technique for affecting air, such as cooling, heating, humidification, dehumidification, or adding or removing any species to or from air.

Another feature provided by the valve arrangement illustrated in FIGS. 1A and 1B is efficiency achieved through simultaneous gas flow through a single valve, defining different gas flow pathways. As can be seen, a plurality of gas streams flow, simultaneously, through the valve depending upon setting of baffle 20. And the gas streams are essentially entirely isolated from each other in the embodiment illustrated. In other arrangements not illustrated, more than two gas streams can be provided by multiple baffles. In still other embodiments, the gas streams are primarily isolated but intermixed at least to some degree, but in most embodiments are not fully intermixed and/or homogenized.

In one embodiment, at least one gas flow pathway, or each gas flow pathway of the valve (for example, the two gas flow pathways in the embodiment illustrated in FIGS. 1A and 1B) comprises at least 5% of the common gas flow space. In another set of embodiments, at least one gas flow pathway, or each gas flow pathway of the valve comprises at least 10%, 15%, 20%, 25%, 30%, 35%, 40%, 45%, or comprises about 50% of common gas flow space.

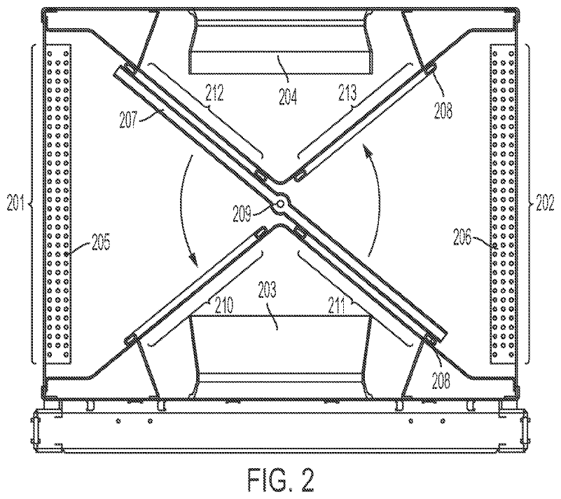

FIG. 2 an illustrative diagram of a cross-sectional of the system comprising the air directing valve 207 that rotates around the central axis of rotation 209. In FIG. 1, the air directing valve 207 is configured to connect inlet 201 to outlet 203, connect inlet 202 to outlet 204, and inhibit flow through air paths 211 and 212. In this embodiment, heat and/or mass transfer devices 205 and 201 are positioned in inlets 201 and 202, respectively. This is so that the gas stream entering the inlets may pass through and/or over the heat and/or mass transfer devices. The arrows denote how directing valve 207 may rotate into a second position (e.g., as in FIGS. 1A-B). Finally, flexible seals 208 are positioned on each air path 210, 211, 212, and 213. The flexible seals 208 may deform and allow for a seal of the air paths when the directing valve 207 pressures the flexible seals 208 (e.g., as shown in air paths 211 and 212 in FIG. 2). In some embodiments, the flexible seals may be or comprise gaskets.

While illustrate in FIGS. 1-2 that the air directing valve may rotate along a central axis, it is also contemplated that the air directing valve may rotate from another axis. For example, the valve may rotate about an axis on the periphery of the valve. In some cases, the valve may comprise two or more baffles which may independently rotate about axes that may or may not be central to each baffle independently.

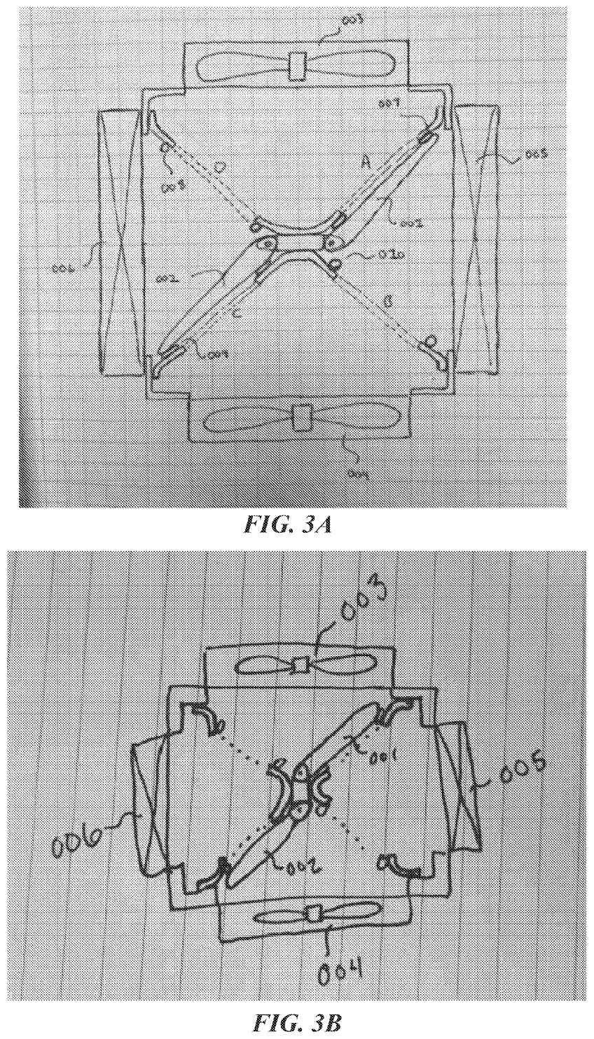

For example, consider FIG. 3A which is an illustrative diagram of an air directing valve comprising a first baffle 001 and a second baffle 002. Each baffle may independently rotate about an axis, and thus the first and/or the second baffle may be switchable between at least a first configuration and a second configuration. In some cases, combinations of the configurations for each baffle may enable at least 2, at least 3 or at least 4 configurations for the valve. Different configurations may facilitate different air flow paths between the air passages 003, 004, 005, and 006. For example, as illustrated in FIG. 3A, the dual-baffle air directing valve may function similarly to the air directing valve of FIGS. 1-2, connecting inlet 005 with outlet 004 and connecting inlet 006 with outlet 003. In another arrangement of FIG. 3A, wherein baffle 001 blocks air path A and baffle 002 blocks air path D, the systems operate differently than from the embodiments of FIGS. 1-2. That is, inlets 005 and 006 are in fluid communication with outlet 004. In this case, outlet 003 is fluidically isolated (e.g., flow is inhibited) from each of the other inlets and outlets). Such a configuration may be advantageous for isolating and inlet and/or outlet when, for example, there may be a significant temperature gradient to the isolated inlet and/or outlet (e.g., the isolated inlet leads to outdoors where the temperature is relatively high or low when compared to indoors). In some cases, the valve assembly shown in FIG. 3A may be rotated 90 degrees relative to the gas ports, as shown in FIG. 3B. Different flow paths may be achieved by using this alternative valve configuration, according to such embodiments. For example, each inlet may still be able to be fluidically connected to either outlet. In some such cases, however, inlet 006 or inlet 005 may be independently isolated, while the other inlet may be in fluid communication with both outlets.

The gas directing valve and/or other components of a valve assembly and/or housing, optionally including sealing materials where a baffle abuts against a portion of a housing, may comprise a relatively thermally insulating material, which may be advantageous when the system is operating such that air on a first portion of a valve assembly is warmer or cooler than in a different portion of the valve assembly (as is apparent from the description of various valve assemblies in this disclosure and understanding of other optional arrangements enabled by what is disclosed). For example, consider the non-limiting example shown in FIG. 1A. Air flowing from inlet 113 to outlet 117 may be heated whereas the air flowing from inlet 115 to 118 may be cooled. Thus, there may be a temperature gradient across the gas directing valve 106. To minimize heat transfer between gas streams and to optimize heating and/or cooling, relatively thermally insulating material for the gas directing valve. In some cases, the valve may be coating in a thermally insulating material. Non-limiting examples of materials for the gas directing valve and/or for coating the gas directing valve include ceramics, fiberglass, polyisocyanurate, and polystyrene. Other materials are also possible.

Again, thermal insulation may be a desirable property for the material of the gas directing valve and/or other components of systems disclosed herein, and various levels of insulation may be desirable in certain circumstances. Insulative properties between different sections of systems of the invention can be determined routinely in any of a variety of suitable ways known to those of ordinary skill in the art. In some cases, the material of any component of a valve assembly or other system of this disclosure, such as housing components (e.g., those that separate different gas flow regions depending on the arrangement or setting of the assembly, and/or a gas directing valve or baffle itself) may have a thermal conductivity of less than or equal to 50 Wm⁻¹K⁻¹, less than or equal to 30 Wm⁻¹K⁻¹, less than or equal to 10 Wm⁻¹K⁻¹, less than or equal to 8 Wm⁻¹K⁻¹, less than or equal to 5 Wm⁻¹K⁻¹, less than or equal to 3 Wm⁻¹K⁻¹, less than or equal to 2 Wm⁻¹K⁻¹, less than or equal to 1 Wm⁻¹K⁻¹, less than or equal to 0.5 Wm⁻¹K⁻¹, or less than or equal to 0.1 Wm⁻¹K⁻¹. In some embodiments, regions of a valve assembly of this disclosure, defining different gas flow pathways (optionally through different settings of a vale or baffle), will be separated from each other by a baffle (positioned per a relevant setting) and other portions of the housing such that a first region or gas flow pathway, and a second region or gas flow pathway, are separated from each other by components defining an R-value of greater than or equal to 0.01 m²KW⁻¹, greater than or equal to 0.1 m²KW⁻¹, greater than or equal to 0.2 m²KW⁻¹, greater than or equal to 0.3 m²KW⁻¹, greater than or equal to 0.5 m²KW⁻¹, greater than or equal to 0.8 m²KW⁻¹, greater than or equal to 1 m²KW⁻¹, greater than or equal to 1.5 m²KW⁻¹, greater than or equal to 2 m²KW⁻¹, greater than or equal to 3 m²KW⁻¹, greater than or equal to 5 m²KW⁻¹, greater than or equal to 8 m²KW⁻¹, or greater than or equal to 10 m²KW⁻¹ between the at least two gas streams. In some cases, the R-value may be less than or equal to 10 m²KW⁻¹, less than or equal to 8 m²KW⁻¹, less than or equal to 5 m²KW⁻¹, less than or equal to 3 m²KW⁻¹, less than or equal to 2 m²KW⁻¹, less than or equal to 1.5 m²KW⁻¹, less than or equal to 1 m²KW⁻¹, less than or equal to 0.8 m²KW⁻¹, less than or equal to 0.5 m²KW⁻¹, less than or equal to 0.3 m²KW⁻¹, less than or equal to 0.2 m²KW⁻¹, or less than or equal to 0.1 m²KW-1.

Other components of the system may also comprise thermally insulating material, according to some embodiments. In some cases, materials used to construct components of the system other than the gas directing valve may have a thermal conductivity of less than or equal to 50 Wm⁻¹K⁻¹, less than or equal to 30 Wm⁻¹K⁻¹, less than or equal to 10 Wm⁻¹K⁻¹, less than or equal to 8 Wm⁻¹K⁻¹, less than or equal to 5 Wm⁻¹K⁻¹, less than or equal to 3 Wm⁻¹K⁻¹, less than or equal to 2 Wm⁻¹K⁻¹, less than or equal to 1 Wm⁻¹K⁻¹, less than or equal to 0.5 Wm⁻¹K⁻¹, or less than or equal to 0.1 Wm⁻¹K⁻¹.

In various arrangements described above, the cooling and dehumidification of air is described as but one example (along with associated heating and humidification of air in what typically will be a waste stream of hot, moist air). Non-limiting examples of suitable adsorbents include desiccant materials such as alumina, silica gels, zeolites, metal-organic framework compounds (MOFs), and activated carbons. Other desiccants can be used.

This disclosure, however, is not limited to adsorbents that are desiccants. Those of ordinary skill in the art will understand how to select different adsorbents and/or other components for such purposes, and how to arrange or connect the components so that they remove and/or drive off species where and when desired. In one set of embodiments, suitable adsorbents can be composed of (among other optional ingredients such as binders, etc.) a material capable of capturing a species from a gas (adsorption) under a first set of conditions and releasing the same species (desorption) under a second set of conditions. An example of such conditions includes cooling and heating, respectively, where an adsorbent is selected to it's our water vapor and release water vapor. Non-limiting examples of adsorbent materials for adsorbing/desorbing species include carbonaceous materials (e.g., activated carbon, graphene, and/or carbon nanotubes), zeolites, MOFs, porous polymers, alumina, silica, and metal oxide. Other adsorbents are possible. Desiccants used herein are typically a subset of adsorbents in which the adsorbed and desorbed species is water.

A variety of gases can be controlled by devices and systems described, and in one set of embodiments the disclosure relates to simply directing a gas flow from one source or sources to a different source or sources. In another set of embodiments, a different gas or gases can be used. Whether air is used, or a different gas, the gas can be treated or untreated, and if treated can be treated differently than is described above. For example, various particulate, chemical, biological, or other species can be removed from and driven into gas flow pathways as described above via different adsorbents or other components. Gases can include essentially any gas such as nitrogen, oxygen, carbon dioxide, exhaust or waste/flue gas streams, or the like. Non-limiting examples of gasses, and species for adsorption and/or desorption, which can be used in accordance with this disclosure include: air and water (e.g., for HVAC/dehumidification/water harvesting), air and CO₂ for carbon capture or indoor air quality (IAQ), flue gas and CO₂ for carbon capture, H₂ and H₂ for hydrogen storage, air and VOCs for IAQ, air and CO for IAQ, NH₃ and NH₃ for energy storage, CO₂ and CO₂ for energy storage. Where two of the same thing are noted together above, one is an example of the gas, and the other (same species), can be and adsorbed and/or desorbed. As noted, this is simply a set of examples, and those of ordinary skill will be able to apply this disclosure to many other gases and species.

Additionally, in all such arrangements, different treatments of the gas can be provided at any position with regard to inlets or outlets of the systems described above, including multiple treatments such as heating and/or cooling while at the same time adsorbing and/or releasing species from and into a gas stream. That is, the incoming gas may encounter a heat and/or mass transfer device. In some cases, when the system comprises two gas streams, one gas stream may be heated while another gas stream may be cooled. In some cases, two gas streams may be cooled. Both gas streams may be heated, in accordance with some embodiments. In some embodiments, one or both gas streams may pass over or through a heat and/or mass transfer device wherein primarily only mass transfer occurs (e.g., a condenser and/or evaporator are not active in the system) at the heat and/or mass transfer device. Of course, arrangements and treatments of the gas are possible, wherein concurrently in different gas streams or subsequently within the same gas stream, for example, water is initially removed from a gas stream at a first heat and/or mass transfer device and then CO₂ is removed from the gas stream at a second heat and/or mass transfer device downstream of the first heat and/or mass transfer device.

In one set of embodiments, gases and/or species may be adsorbed from the two gas streams, while heat transfer as described above may occur. In some cases, heat transfer does not occur in the presence mass transfer (e.g., adsorption and/or desorption). In some cases, as described elsewhere herein, the adsorbents positioned to interact with each gas stream are the same material, and thus adsorb and/or desorb the same gas and/or species from the gas streams. In some cases, the adsorbent in each gas stream may be different, intending to adsorb and/or desorb different species from the incoming gas streams. According to some embodiments, it may be advantageous to use combinations of adsorbents. As a non-limiting example, in some cases, it may be beneficial pass the gas stream over and/or through a first heat and/or mass transfer device designed to adsorb water, wherein the gas stream is then passed over and/or through a first heat and/or mass transfer device designed to adsorb CO₂. Other arrangements where multiple adsorbents are used are also possible. For instance, in some cases, two adsorbents may be coated on a single heat and/or mass transfer device. In some such cases, the two adsorbents may concurrently adsorb different gases and/or species from the gas stream.

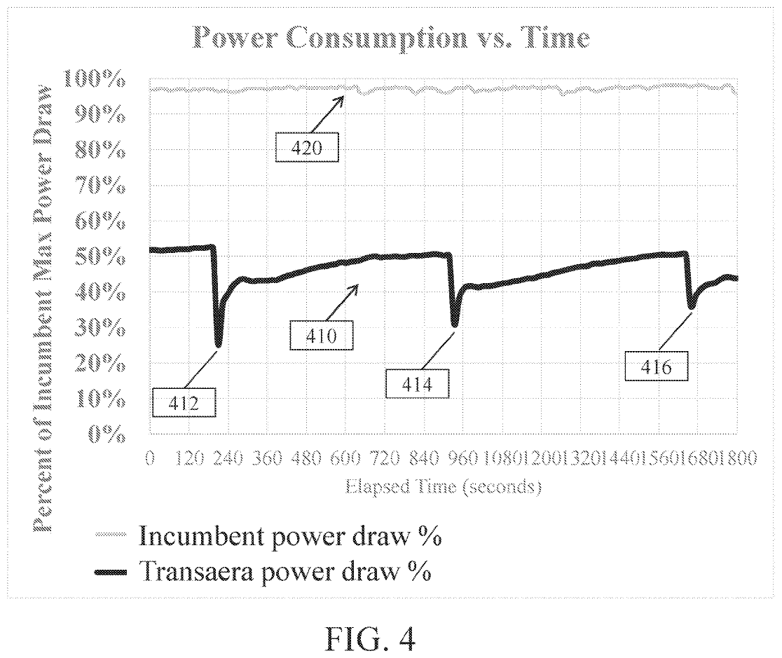

In some cases, as shown in FIG. 4, the period after the switch between modes where power draw is relatively low (e.g., compared to steady state without switching and/or right before switching) may not be constant. According to some embodiments, there may be different periods or phases after switching the system from a first mode to a second mode. There may be a first phase, a second phase, and/or a third phase after switching, in accordance with some embodiments.

The first phase after switching may be transient, in some cases. The first phase may be associated with a period after the switch due to the pressure equalizing, flow (e.g., of the gas streams and/or refrigerant) changing directions, and/or the thermal mass changing temperatures. In some cases, the first phase may last a relatively short time, for example, greater than or equal to 10 seconds, greater than or equal to 30 seconds, greater than or equal to 1 minute, greater than or equal to 2 minutes, greater than or equal to 3 minutes, greater than or equal to 5 minutes, greater than or equal to 8 minutes, greater than or equal to 10 minutes, greater than or equal to 15 minutes, greater than or equal to 20 minutes, or greater than or equal to 25 minutes. In some embodiments, the first phase may last less than or equal to 30 minutes, less than or equal to 25 minutes, less than or equal to 20 minutes, less than or equal to 15 minutes, less than or equal to 10 minutes, less than or equal to 8 minutes, less than or equal to 5 minutes, less than or equal to 3 minutes, less than or equal to 2 minutes, less than or equal to 1 minutes, or less than or equal to 30 seconds. Combinations of the foregoing ranges are possible (e.g., greater than or equal to 10 seconds and less than or equal to 30 minutes, greater than or equal to 30 seconds and less than or equal to 20 minutes). Other ranges are also possible.

The second phase, in accordance with some embodiments, is generally related to the period of time after the immediate transient (e.g., the first phase) wherein the adsorbent is adsorbing and/or desorbing at an appreciable rate. An appreciable rate is to be understood as a rate that can be measured, whether as a change in absolute humidity and/or concentration of other gases/species from the gas stream. For example, the absolute humidity change measured between a first and second humidity sensor upstream and downstream (e.g., at an inlet and an outlet) of the adsorbent, respectively, may inform about the rate of adsorption and/or desorption. Of course, when adsorbing species other than water, other sensors (e.g., a CO₂ sensor) may be used in place of the humidity sensor. In some embodiments, the absolute humidity change between two humidity sensors may be greater than or equal to 1%, greater than or equal to 2%, greater than or equal to 3%, greater than or equal to 5%, greater than or equal to 8%, greater than or equal to 10%, greater than or equal to 15%, or greater than or equal to 20%. In some cases, the absolute humidity change may be less than or equal to 20%, less than or equal to 15%, less than or equal to 10%, less than or equal to 8%, less than or equal to 5%, less than or equal to 3%, less than or equal to 2%, or less than or equal to 1%. Combinations of the foregoing ranges are possible (e.g., greater than or equal to 1% and less than or equal to 5%). Other ranges are also possible. In some cases, to measure the absolute humidity (e.g., a humidity ratio) a combination of temperature sensors and relative humidity sensors may be used, whereafter the absolute humidity may be calculated.

The second phase may last a variable amount of time, in accordance with some embodiments, which may depend on the amount of adsorbent on the heat and/or mass transport device and/or the amount of species that is present in the gas stream and/or the gas flow rate through the heat and/or mass transfer device. In some cases, the second phase may last greater than or equal to 1 minute, greater than or equal to 2 minutes, greater than or equal to 3 minutes, greater than or equal to 5 minutes, greater than or equal to 8 minutes, greater than or equal to 10 minutes, greater than or equal to 15 minutes, greater than or equal to 20 minutes, greater than or equal to 25 minutes, greater than or equal to 30 minutes, greater than or equal to 45 minutes, or greater than or equal to 1 hours. In some embodiments, the second phase may last less than or equal to 2 hours, less than or equal to 1 hour, less than or equal to 45 minutes, less than or equal to 30 minutes, less than or equal to 25 minutes, less than or equal to 20 minutes, less than or equal to 15 minutes, less than or equal to 10 minutes, less than or equal to 8 minutes, less than or equal to 5 minutes, less than or equal to 3 minutes, or less than or equal to 2 minutes. Combinations of the foregoing ranges are possible (e.g., greater than or equal to 2 minutes and less than or equal to 2 hours, greater than or equal to 3 minutes and less than or equal to 1 hour). Other ranges are also possible.

The third phase occurs after the second phase and is associated with the adsorbent being substantially (un) saturated, in some cases. According to some embodiments, when the adsorbent is adsorbing a species, the third phase occurs when the adsorbent is fully adsorbed (e.g., the adsorbent has no remaining capacity to appreciably adsorb a species). In some cases, when the adsorbent is desorbing species, the third phase occurs when the adsorbent is fully desorbed (e.g., essentially the full capacity of the adsorbent is available to adsorb a species). As described above, the amount of adsorption/desorption may be determined by measuring the humidity (e.g., or concentration of another species) upstream and downstream of the adsorbent. If no change is observed in the concentration of the species being measured, the system may be in the third phase wherein the adsorbent is fully saturated and/or desaturated. In some cases, the third phase may be determined by monitoring the power draw as shown in FIG. 4, where the power draw approaches the initial power draw before each switch and has a relatively slow rate of change compared to times immediately after the switch (e.g., at time=840 s).

The third phase may last a variable amount of time, in accordance with some embodiments. In some cases, the third phase may continue until the system is switched between the first and the second mode. In some cases, the third phase may last greater than or equal to 5 minutes, greater than or equal to 15 minutes, greater than or equal to 30 minutes, or greater than or equal to 1 hour. In some embodiments, the third phase may last less than or equal to 2 hours, less than or equal to 1 hours, less than or equal to 30 minutes, or less than or equal to 15 minutes. Combinations of the foregoing ranges are possible (e.g., greater than or equal to 5 minutes and less than or equal to 1 hour). Other ranges are also possible.

It may be advantageous, in some cases, to adjust various control parameters to account for the different phases because the system may require less energy to output the same cooling (e.g., or heating) load. In some embodiments, fine tuning the system to account for the different phases may optimize the latent vs sensible loads for cooling, heating, and/or changing the composition of the air (e.g., humidifying). For example, when compared to air conditioning systems comprising an adsorbent that do not account for the different phases, the present system may require greater than or equal to 1%, greater than or equal to 2%, greater than or equal to 3%, greater than or equal to 4%, greater than or equal to 5%, greater than or equal to 8%, greater than or equal to 10%, greater than or equal to 15%, greater than or equal to 20% less energy than the total energy required by other systems. In some cases, the present system may require less than or equal to 20%, less than or equal to 15%, less than or equal to 10%, less than or equal to 8%, less than or equal to 5%, less than or equal to 4%, less than or equal to 3%, less than or equal to 2%, or less than or equal to 1% less energy than the total energy required by conventional systems. combinations of the foregoing ranges are possible (e.g., greater than or equal to 1% and less than or equal to 2%). Other ranges are also possible.

As mentioned above, various parameters may be altered to account for the different phases in order to improve energy efficiency from the system. In some cases, during the first phase, there is a first setting of parameters, during the second phase there is a second setting of parameters, and during the third phase there is a third setting of parameters. Parameters that may be altered include changing compressor speed, adjusting position of expansion valve from fully closed to fully open, and/or changing the speeds of fans. It may be beneficial, in accordance with some embodiments, to change one parameter to account for the changing phases. In some cases, more than one parameter may be changed to account for changing phases. In some cases, the parameters are changed when the system is switched between the first mode and the second mode and/or when the system progresses from the first phase to the second phase and/or when the system progresses from the second phase to the third phase. Multiple changes to the system parameters are possible, and the system controller may alter the parameters as the system operates. For example, the controller may switch parameters when the system switches from a first mode to a second mode (e.g., initiating the first phase of the second mode), when the system changes from the first phase to the second phase, when changing from the second phase to the third phase, when switching from the second mode to the first mode (e.g., initiating the first phase of the first mode), and so forth as long as the system is operating.

According to some embodiments, changing of system parameters may occur after predetermined amounts of time. For example, in some cases, the system controller may change at least one system parameter after switching between a first mode and a second mode. In some embodiments, the controller may automatically switch parameters to correspond with the transition from the first phase to the second phase, which in some cases, may be after 30 seconds, after 2 minutes, after 10 minutes, or after other amounts of time have elapsed in the first phase, as disclosed elsewhere herein. Similar control may be utilized for shifting parameters as the system progresses from the second to the third phase. Examples of other non-limiting control systems, e.g., based on power draw, temperature, and/or humidity are possible, some of which are disclosed elsewhere herein.

### Optimal Air Valve Switching

One such method includes switching air directing valve 106 from a first position depicted in FIG. 1A to a second position depicted in FIG. 1B and/or from the second position to the first position based at least in part on a measured absolute humidity ratio (AHR). The system can measure one or more parameters of air streams at one or both of ducts 117 and 118, such as absolute humidity. The system 100 can compare the absolute humidity values at ducts 117 and 118 to determine AHR in the air stream at of ducts 117 or 118 to ensure no moisture is added to the indoor space from the outdoors during cooling. When system 100 switches refrigerant flow direction using reversing refrigerant valve 102, a control method executed by system controller 109 waits until the new hot side AHR (e.g., duct 117 in FIGS. 1A-B) climbs above the new cold side AHR (e.g., duct 118 in FIGS. 1A-B) and only then switches the airflow using air directing valve 106. This ensures that fan 108 is always discharging the higher moisture stream outside and maximizes the dehumidification capacity of the system.

### Optimal Superheat Control

Another method includes automatic super heat control by fixing a position of the expansion valve 104 for a predetermined amount of time after a switch from first mode to second mode or second mode to first mode. Automatic super heat control maintains the refrigerant exit temperature from the cold heat exchanger (e.g., 105 in FIG. 1A or 103 in FIG. 1B) above the saturation temperature of the boiling refrigerant inside the hot heat exchanger (e.g., 103 in FIG. 1A or 105 in FIG. 1B). This avoids passing liquid refrigerant back to the compressor. Immediately after a refrigerant direction is switched with valve 102, the system 100 undergoes a rapid thermal transient on heat exchangers 103 and 105. Operating a conventional automatic superheat control during this transition can result in excessive refrigerant flow and loss of cooling capacity. Advantageously, the present application prevents such excessive flow of refrigerant.

A method to automatically control super heat can fix a position of the expansion valve 104 for a predetermined period of time after a switch. In one example, the predetermined period of time is determined from a lookup table based on empirical testing. Fixing the position of expansion valve 104 for a predetermined period of time after a switch can advantageously prevent a mismatch in the expansion valve 104 flow during the transient. This allows rapid recovery of cold air temperature at supply duct 118. Superheat control can be returned to automatic control after the transient period which is a factor of heat exchanger mass and desiccant loading. In some cases, automatic control may comprise changing at least one parameter after the transient period (e.g., the first phase) at the start of the second phase. According to some embodiments, automatic control may further comprise changing at least one parameter after the second phase at the start of the third phase.

### Selective Dehumidification Control

Referring to the first mode of operation in FIG. 1A, when system 100 is operated without switching the refrigerant flow direction with valve 102, it does not remove moisture from the cooled space (e.g., space that receives airstream from duct 118) because heat exchanger 105 is set above the indoor dew point. Coated heat exchanger 105 has a finite capacity for moisture adsorption. Each time system 100 is switched from the first mode to/from the second mode, heat exchangers 103 and 105 swap roles in the system and a certain amount of moisture can be discharged outdoors from the loaded heat exchanger while the previously unloaded heat exchanger is loaded with moisture in the indoor space. This allows system 100 to select a moisture removal rate independent of the sensible cooling rate. No switching results in 100% sensible cooling with no moisture removal. Switching at the fastest possible rate results in the maximum latent cooling and some reduction in sensible cooling. Minor losses associated with the switch and the time required to recover superheat control will limit the shortest switch time. In this manner the latent cooling is adjusted from zero to a maximum value. Using this feature, a user can select an indoor humidity level that system 100 can maintain in addition to temperature level. In effect, system 100 gives users the ability adjust temperature and humidity independently.

### Compressor Power Draw Switching Control

FIG. 4 depicts a graph of percent of maximum power consumption of a compressor vs. time of a conventional system 420 and the present system 410. In order to minimize the number of temperature and relative humidity sensors required by system 100, it is possible to monitor compressor power draw to determine the optimal switching time for maximum dehumidification. After each switch, system 100 power draw drops substantially, as shown at points 412, 414, and 416. Then power consumption then builds back gradually to a steady state value (e.g., between approximately 40-90%) determined by the indoor temperature, cooling load, and the outdoor conditions. Control system 109 can determine the steady state power draw for the given conditions, for example, by using one or more sensors or other data available to the system 100. Then, by monitoring the compressor power draw, the controller 109 can determine when the system has reached a point of diminishing returns in terms of moisture removal. This generally happens after a power dip associated with a switch and when the power draw has recovered to within 50-90% of the steady state power. At this point the system can switch from a first mode to/from a second mode and monitor power draw rise again. Since compressor power draw is a function of both cold side loading and hot side unloading, the actual coated material and heat exchanger is effectively operating as a sensor. This means there is not a requirement for a carefully calibrated and located temperature and humidity sensor like is required by other systems.

### Adjusting Compressor Speed Before and After a Switch

After system 100 switches from first mode in FIG. 1A to the second mode of FIG. 1B, there is a significant reduction in power consumption as shown above in FIG. 2. This period of low power is primarily due to reduced back pressure at the exit of the compressor 101 due to low refrigerant pressure in the hot side heat exchanger (e.g., 103 in FIG. 1A and 105 in FIG. 1B). During this short time period, it is advantageous to adjust (e.g., accelerate) the compressor rotation speed in order to increase refrigerant flow rate through the system. This in turn provides additional cooling power to the system and speeds up the return to steady state operation between switching cycles. The adjustment to compressor rotation speed can cease when the reduced back pressure on the compress goes away (e.g., when the desiccant has finished unloading).

### Outdoor Condition Switch Time Determination

The power draw reduction in system 100 due to higher evaporator temperature is essentially constant. However, the reduction in power due to an evaporative cooling effect from a loaded coated heat exchanger results in a marked drop in electrical power draw after a switch. This effect can be used to determine a minimum time required to unload the moisture from a loaded heat exchanger. This minimum time can be based on the outdoor wet bulb temperature. A system does not need to measure wet bulb temperature directly; a moisture-loaded heat exchanger is acting as a wet bulb temperature sensor. By monitoring compressor power draw the controller can infer refrigerant high-side pressure and outdoor wet bulb temperature with no additional sensors required. This allows the system to monitor power consumption of the compressor to infer the remaining moisture in the heat exchanger that is currently unloading.

### Heat Plus Humidity Control

In a conventional heat pump, the system is only able to move sensible heat into the conditioned (e.g., indoor) space. This can result in air that is warm and very dry, particularly in winter season when the outdoor air dewpoint is very low. Conventional heat pump systems that provide sensible only heat to air raise the indoor temperature without adding moisture. This results in low relative humidity and uncomfortable environment. By contrast, in system 100, the desiccant coating on heat exchangers 103 and 105 allows system 100 to move both heat and humidity from outdoor to indoor thus resulting in improved comfort for the user. The system does this by gathering heat from outdoor air while adsorbing moisture and then switching to pump that heat and the moisture indoor. This system also has the advantage that it minimizes the efficiency losses due to outdoor unit defrosting. A conventional heat pump has to periodically reverse and pump heat out of the room to melt accumulated ice on the outdoor heat exchanger. System 100 can swap the indoor air to flow over the outside heat exchanger to defrost it using heat gathered from the new outdoor heat exchanger. As the coil is defrosted indoors, the moisture removed helps to further humidify the conditioned space.

### Improved Dry Mode

Many existing mini-split heat pumps include a mode called “dry mode.” This lowers the temperature of the indoor coil and simultaneously reduces indoor airflow to a low setting. This helps the system to remove as much moisture from the air as possible and minimizes the cooling effect on the room. Unfortunately, it still cools the room significantly in the dry mode. In order to operate, the conventional incumbent system should be set at a temperature below the current room temperature. In contrast, the present system 100 allows the user to only dry the room with no cooling effect at all. By adjusting the indoor coil temperature and the switching time, system 100 can remove moisture from the indoor space without lowering the temperature at all. This is put into effect by setting coil 105 temperature using the speed of compressor 101, the opening of valve 104 and the speed settings of fans 108 and 107. Using previously described optimum power consumption of compressor 101 the system can switch air valve 106 to maintain low system power draw, zero sensible cooling and effective moisture removal from the conditioned space. This allows the system to dehumidify the space without affecting the temperature level in the indoor space and without consuming additional power to do so.

### Asynchronous Loading and Unloading

Another technique allows for loading and unloading of exchangers 103, 105 asynchronously whereby a loaded heat exchanger is loading with moisture while one or more loaded heat exchangers continue to hold on to the moisture adsorbed earlier. This enables a form of moisture storage.

Based upon sensor data and/or other data made available to the system 100, controller 109 can determine a current position (e.g., a psychrometric state on a psychrometric chart) for the condition space. A user may adjust a desired humidity and/or temperature for the condition space, which may be a different position (e.g., a second, desired psychrometric state on the psychrometric chart). Controller 109 can determine an optimal path between current position and desired position. Conventional systems typically make such adjustments in a linear fashion, resulting in inefficiency. The present system 100 advantageously can adjust operation of the system 100 (such as by any of the methods or techniques described above), to identify an optimal path between current and desired position, which may include any combination or linear or nonlinear paths. Such optimal path can be determined based upon a lookup table and/or psychometric equations.

In this disclosure systems and methods are provided in which a number of parameters are measured and/or controlled. Where parameters such as temperature, flow rate, pressure, amount of loading or adsorption or amount of unloading or desorption, and the like are used, it is to be understood that they are measured according to techniques available to those of ordinary skill in the art. These are standard in the field of air management or handling, such as heating, air conditioning, humidification, and/or dehumidification. As an example, temperature can be measured with a thermometer such as a thermistor in many applications. And other applications, thermocouples and/or resistance temperature detectors (RTDs) can be used. Where temperature measurement is carried out with respect to condenser or evaporator lines or coils, temperature often is measured in the middle of the line or coil, but also can be measured at the beginning or the end of the line or coil so as to determine factors such as the temperature where condensation begins, where subcooling begins, and subcooled and superheated locations and degrees. Pressure and flow rate sensors are standard, and well understood. In many systems such as those disclosed herein, a flow rate of a refrigerant is not actively measured (although it can be). Volume and/or flow rate of a gas interacting with a system or method of the disclosure can be determined by measuring air flow velocity using an anemometer (such as a hot wire anemometer or a propeller anemometer), and multiplying by the cross-sectional area of the flow stream of interest.

As described elsewhere herein, a system controller (e.g., a computer system) may be configured to switch a valve position, in some embodiments. According to some embodiments, the system controller may be configured to switch the direction of flow of refrigerant (e.g., to change the functionality of the heat and/or mass transfer device between an evaporator and/or a condenser). In some cases, the system controller may be configured to control the compressor speed, the position of expansion valve, and/or the speed of fan(s). In some cases, the controller may be configured to switch the position of the valve assembly and/or the function of the heat and/or mass transfer device. For example, the controller may switch the operation of the heat and/or mass transfer device from heating and desorbing to cooling and adsorbing species from a gas stream. As disclosed elsewhere herein, the switching may be done to optimize device efficiency or due to a change in desired heating, cooling, and/or air composition. The controller may switch any of the foregoing parameters based on information gathered about the system, for example, at sensors. Non limiting examples of information that the controller may use to determine when to vary/switch parameters of the system include temperature, humidity, absolute humidity, absolute humidity ratio, air pressure, and gas flow rate. These parameters may be used individually or in tandem. Other parameters may also be used, as this disclosure is not so limited.

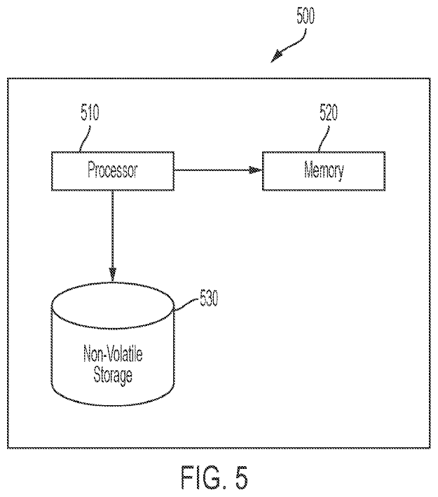

FIG. 5 is a block diagram of an example computer system that is improved by implementing the functions and/or operations described herein. An illustrative implementation of a computer system 500 that may be used in connection with any of the embodiments of the disclosure provided herein is shown in FIG. 5. The computer system 500 may include one or more processors 510 and one or more articles of manufacture that comprise non-transitory computer-readable storage media (e.g., memory 520 and one or more non-volatile storage media 560). The processor 510 may control writing data to and reading data from the memory 520 and the non-volatile storage device 530 in any suitable manner. To perform any of the functionality described herein, the processor 510 may execute one or more processor-executable instructions stored in one or more non-transitory computer-readable storage media (e.g., the memory 520), which may serve as non-transitory computer-readable storage media storing processor-executable instructions for execution by the processor 510. The exemplary computer system is a non-limiting embodiment of a controller for the systems described herein and may be configured to control the mode of the system (e.g., adsorbing vs desorbing, heating vs cooling, etc.) and/or system parameters (e.g., compressor speed, position of expansion valve, and/or fan speed, etc.) at different times.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, as used herein, the terms “process” and/or “processor” should be taken broadly to include a variety of electronic hardware and/or software based functions and components (and can alternatively be termed functional “modules” or “elements”). Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Additionally, as used herein various directional and dispositional terms such as “vertical”, “horizontal”, “up”, “down”, “bottom”, “top”, “side”, “front”, “rear”, “left”, “right”, and the like, are used only as relative conventions and not as absolute directions/dispositions with respect to a fixed coordinate space, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances of the system (e.g. 1-5 percent). Accordingly, this description is meant to be taken only by way of example, and not to otherwise limit the scope of this invention.

What is claimed is:

1. A system, comprising:
a heat pump, comprising at least a first heat and/or mass transfer device, and an adsorbent in thermal communication therewith, configured to adsorb and/or desorb a species from a gas exposed thereto; and
a controller configured to set the heat pump in a first mode in which the adsorbent is adsorbing a species, and to switch the heat pump from the first mode to a second mode in which the adsorbent is desorbing a species,
wherein the controller is configured to substantially change at least one heat pump condition during the first mode and/or the second mode.

2. A system as in claim 1, wherein the heat pump comprises at least the first heat and/or mass transfer device and a second heat and/or mass transfer device, each of the first and second heat and/or mass transfer devices comprises an adsorbent in thermal communication therewith, and the controller is configured to set the heat pump in a first mode in which the adsorbent associated with the first heat and/or mass transfer device is adsorbing a species and the adsorbent associated with the second heat and/or mass transfer device is desorbing a species, and to switch the heat pump from the first mode to a second mode in which the adsorbent associated with the first heat and/or mass transfer device is desorbing a species and adsorbent associated with the second heat and/or mass transfer device is adsorbing a species.

3. A system as in any one of the preceding claims, wherein the controller is configured to manage the heat pump through at least three phases of operation in at least one of the first mode and/or or the second mode, the at least three phases comprising:
a first phase beginning when the heat pump is switched from a first mode to a second mode, and lasting for a period of time of between 10 seconds and 30 minutes,
a second phase beginnings with the end of the first phase and lasting for a period of time of between 2 minutes and 2 hours, and
a third phase beginning with the end of the second phase, and ending when the heat pump is switched from the second mode to the first mode.

4. A system as in any one of the preceding claims, wherein:
the first phase lasts for a period of time of between 30 seconds and 20 minutes, and
the second phase lasts for a period of time of between 3 minutes and 1 hour.

5. A system as in any one of the preceding claims, wherein the controller is configured to manage the heat pump through at least three phases of operation in at least one of the first mode and/or or the second mode, the at least three phases comprising:
a first phase begins when the heat pump is switched from a first mode to a second mode, the first phase ends when the temperature at which refrigerant evaporating in one heat and/or mass transfer device reaches an essentially steady state, and/or the temperature at which refrigerant is condensing in another heat and/or mass transfer device reaches an essentially steady state, whichever is later,
during a second phase, adsorbent in thermal communication with one heat and/or mass transfer device is adsorbing, resulting in an evaporator refrigerant temperature appreciably higher than a comparative evaporator refrigerant temperature under essentially identical conditions absent the adsorbent, and/or desorbing, resulting in a condenser refrigerant temperature appreciably lower than a comparative condenser refrigerant temperature under essentially identical conditions absent the adsorbent, and
the second phase ends when the adsorption or desorption nears completion, and the temperature of the heat and/or mass transfer device associated with adsorption or the temperature of the heat and/or mass transfer device associated with desorption therefor changes appreciably, whichever is later.

6. A system as in any one of the preceding claims, wherein the controller is configured to manage the heat pump through the at least three phases of operation in each of the first mode and the second mode.

7. A system as in any one of the preceding claims, wherein the controller is configured to cycle the heat pump through repeated switches from the first mode to the second mode, then again to the first mode and again to the second mode.

8. A system as in any one of the preceding claims, wherein the controller is configured to substantially change at least one heat pump condition during both the first mode and the second mode.

9. A system as in any one of the preceding claims, wherein the controller is configured to substantially change at least two heat pump conditions during the first mode and/or the second mode.

10. A system as in any one of the preceding claims, wherein the controller is configured to substantially change at least one heat pump condition at least twice during the first mode and/or the second mode.

11. A system as in any one of the preceding claims, wherein the heat pump comprises:
a compressor;
a refrigerant reversing valve; and
an expansion valve.

12. A system as in any one of the preceding claims, wherein the controller is configured to substantially change at least one heat pump condition selected from the group of:
refrigerant flow direction; and/or
compressor speed; and/or
expansion valve position; and/or
speed of one or more fans affecting the rate of airflow across the first and/or second heat and/or mass transfer device.

13. A system as in any one of the preceding claims, wherein the controller is configured to substantially change at least one heat pump condition approximately at the change from the first phase to the second phase.

14. A system as in any one of the preceding claims, wherein the at least one heat pump condition comprises compressor speed.

15. A system as in any one of the preceding claims, wherein the at least one heat pump condition comprises expansion valve position.

16. A system as in any one of the preceding claims, wherein the controller is configured to substantially change at least one heat pump condition approximately at the change from the second phase to the third phase.

17. A system as in any one of the preceding claims, wherein the at least one heat pump condition comprises compressor speed.

18. A system as in any one of the preceding claims, wherein the switch from the first mode to the second mode is based in part upon an absolute humidity ratio.

19. A system as in any one of the preceding claims, wherein the switch from the first mode to the second mode is based in part upon a measured power draw of the compressor.

20. A system as in any one of the preceding claims, where the controller is configured to determine an optimal path from a current psychometric state to a desired psychometric state.

21. A method of operating a heat pump, comprising:
detecting an absolute humidity ratio; and
switching the heat pump from a first mode in which at least a first heat and/or mass transfer device is loaded and at least a second heat and/or mass transfer device is unloaded to a second mode in which the first heat and/or mass transfer device is unloaded and the second heat and/or mass transfer device is loaded.

22. A method of operating a heat pump, comprising:
setting the heat pump in a first mode in which at least a first heat and/or mass transfer device is loaded and at least a second heat and/or mass transfer device is unloaded;
substantially changing at least one heat pump condition during the first mode; and
switching the heat pump from the first mode to a second mode in which the first heat and/or mass transfer device is unloaded and the second heat and/or mass transfer device is loaded.

23. A gas handling system, comprising:
a valve assembly housing, comprising at least first, second, third, and fourth gas ports, each configured to receive an inlet gas stream into the housing or to deliver an outlet gas stream from the housing;
a heat and/or mass transfer device, configured to allow heat and/or mass transfer with a gas in an inlet gas stream or an outlet gas stream;
a valve assembly configured to:
(a) establish fluid communication between the first gas port and the second gas port, while inhibiting fluid communication between the first gas port and the third and fourth gas ports, or
(b) establish fluid communication between the first gas port and the second and third gas ports, while inhibiting fluid communication between the first gas port and the fourth gas port.

24. A system or method as in any one of the preceding claims, comprising:
at least a first gas inlet port and a second gas inlet port, the first gas inlet port configured to receive a first inlet gas stream, and the second gas inlet port configured to receive a second inlet gas stream;
at least a first gas outlet port and a second gas outlet port, the first gas outlet port configured to deliver a first outlet gas stream, and the second gas outlet port configured to deliver a second outlet gas stream;
wherein each of the first and second gas inlet ports is fluidly connectable to either of the first or second gas outlet ports.

25. A system or method as in any one of the preceding claims, wherein the valve assembly is switchable between at least three configurations, including:
a first configuration in which the first inlet port is in fluid communication with the first outlet port and the second inlet port is in fluid communication with the second outlet port, and fluid communication between the first inlet port and the second outlet port is inhibited and fluid communication between the second inlet port and the first outlet port is inhibited,
a second configuration in which the first inlet port is in fluid communication with the second outlet port and the second inlet port is in fluid communication with the first outlet port, and in which fluid connection between the first inlet port and the first outlet port is inhibited and connection between the second inlet port and the second outlet port is inhibited, and
a third configuration in which (a) the first and second inlet ports are in fluid communication with the first outlet port, and fluid connection between the second outlet port and the first and second inlet ports is inhibited, or (b) the first and second outlet ports are in fluid communication with the first inlet port, and fluid connection between the second inlet port and the first and second outlet ports is inhibited.

26. A system or method as in any one of the preceding claims, wherein the valve assembly is switchable between at least the first, second, and third configurations, and a fourth configuration in which the first and second inlet ports are in fluid communication with the second outlet port, and fluid connection between the first outlet port and the first and second inlet ports is inhibited.

27. A system or method as in any one of the preceding claims, wherein the valve assembly comprises a single, integral baffle switchable between a first configuration in which the first inlet port is in fluid communication with the first outlet port and the second inlet port is in fluid communication with the second outlet port, and in which fluid connection between the first inlet port and the second outlet port is inhibited and connection between the second inlet port and the first outlet port is inhibited,
and a second configuration in which the first inlet port is in fluid communication with the second outlet port and the second inlet port is in fluid communication with the first outlet port, and in which fluid connection between the first inlet port and the first outlet port is inhibited and connection between the second inlet port and the second outlet port is inhibited.

28. A system or method as in any one of the preceding claims, wherein the valve assembly comprises at least two separately actuatable baffles.

29. A system or method as in any one of the preceding claims, wherein:
the first baffle is switchable between a first configuration in which the first inlet port is in fluid communication with the first outlet port and fluid communication between the first inlet port and the second outlet port is inhibited, and a second configuration in which the first inlet port is in fluid communication with the second outlet port and fluid communication between the first inlet port and the first outlet port is inhibited, and
the second baffle is switchable between a first configuration in which the second inlet port is in fluid communication with the first outlet port and fluid communication between the second inlet port and the second outlet port is inhibited, and a second configuration in which the second inlet port is in fluid communication with the second outlet port and fluid communication between the second inlet port and the first outlet port is inhibited.

30. A system or method as in any one of the preceding claims, wherein:
the first baffle is switchable between a first configuration in which the first inlet port is in fluid communication with the first outlet port and fluid connection between the second inlet port and the first outlet port is inhibited, and a second configuration in which second inlet port is in fluid communication with the first outlet port and fluid connection between the first inlet port and the first outlet port is inhibited, and
the second baffle is switchable between a first configuration in which the second inlet port is in fluid communication with the second outlet port and fluid connection between the first inlet port and the second outlet port is inhibited, and a second configuration in which the first inlet port is in fluid communication with the second outlet port and fluid connection between the second inlet port and the second outlet port is inhibited.

31. A system or method as in any one of the preceding claims, wherein each the first and second baffles can be in their first or second configurations independently of the configuration of the other baffle.

32. A system or method as in any one of the preceding claims, comprising at least first and second, separately actuatable baffles, wherein at least one baffle is switchable between a first configuration inhibiting fluid connection between at least one inlet port and outlet port and allowing fluid flow between at least a different inlet port/outlet port combination.

33. A system or method as in any one of the preceding claims, wherein the first and second gas inlet ports are connected to a common source of a gas.

34. A system or method as in any one of the preceding claims, wherein the first, second, third, and fourth ports are fluidly connected to a common gas flow space within the housing.

35. A system or method as in any one of the preceding claims, wherein:
the first and second gas inlet ports and the first and second gas outlet ports are fluidly connected to a common gas flow space within the housing, and
the device is configured to direct flow of a first gas stream from the first gas inlet port through the common gas flow space and out the first gas outlet port while flowing a second gas stream from the second gas inlet port through the common gas flow space and out the second gas outlet port, and to direct flow of the first gas stream from the first gas inlet port through the common gas flow space and out the second gas outlet port while flowing the second gas stream from the second ga inlet port through the common gas flow space and out the first gas outlet port.

36. A system or method as in any one of the preceding claims, wherein:
the device is configured to direct flow of the first gas stream from the first gas inlet port through the common gas flow space and out the first gas outlet port and inhibiting the first gas stream from flowing from the first gas inlet port to the second gas outlet port, while directing flow of the second gas stream from the second gas inlet port through the common gas flow space and out the second gas outlet port and inhibiting the second gas stream from flowing from the second gas inlet port to the first gas outlet port; and
is configured to direct flow of the first gas stream from the first gas inlet port through the common gas flow space and out the second gas outlet port and inhibiting the first gas stream from flowing from the first gas inlet port to the first gas outlet port, while directing flow of the second gas stream from the second gas inlet port through the common gas flow space and out the first gas outlet port and inhibiting the second gas stream from flowing from the second gas inlet port to the second gas outlet port.

37. A system or method as in any one of the preceding claims, wherein:
establishing fluid communication between one of the gas inlet ports and one of the gas outlet ports comprises establishing a fluid pathway between the gas inlet port and the gas outlet port, the gas inlet port and the gas outlet port each having a cross-sectional area, in which the fluid pathway has a cross-sectional area at all locations which is at least 40% of the cross-sectional area of the smaller of the cross-sectional areas of the gas inlet port and the gas outlet port; and
inhibiting fluid communication between one of the gas inlet ports and one of the gas outlet ports comprises establishing a fluid pathway between the gas inlet port and the gas outlet port, said gas inlet port and gas outlet port each having a cross-sectional area, in which the fluid pathway has a cross-sectional area at all locations which is less than 40% of the cross-sectional area of the smaller of the cross-sectional areas of said gas inlet port and gas outlet port, or essentially entirely inhibiting fluid communication such that there is essentially no fluid pathway between the gas inlet port and the gas outlet port.

38. A system or method as in any one of the preceding claims, wherein:
establishing fluid communication between one of the gas inlet ports and one of the gas outlet ports comprises establishing fluid flow which has an inlet flow rate passing through the gas inlet port and an outlet flow rate passing through the gas outlet port, wherein the outlet flow rate is at least 10% as great as the inlet flow rate, and
inhibiting fluid communication between one of the gas inlet ports and one of the gas outlet ports comprises establishing fluid flow which has an inlet flow rate passing through the gas inlet port and an outlet flow rate passing through the gas outlet port, wherein the outlet flow rate is less than 10% of the cross-sectional area of the smaller of the cross-sectional areas of said gas inlet port and gas outlet port or essentially entirely inhibiting fluid communication such that there is essentially no fluid pathway between the gas inlet port and the gas outlet port.

39. A system or method as in any one of the preceding claims, wherein the system includes insulative components selected and positioned such that when inhibiting fluid communication between a first port and a second port, an insulative R value of at least 0.1 m²KW⁻¹ is established between the first port and the second port.

40. A system or method as in any one of the preceding claims, wherein both baffles are switchable between a first configuration inhibiting fluid connection between at least one inlet port and outlet port and allowing fluid flow between at least a different inlet port and outlet port combination.

41. A method of affecting gas flow, comprising:
flowing a first gas stream from a first gas inlet port through a common gas flow space and out a first gas outlet port while flowing a second gas stream from a second gas inlet port through the common gas flow space and out a second gas outlet port; and
flowing the first gas stream from the first gas inlet port through the common gas flow space and out the second gas outlet port while flowing the second gas stream from the second gas inlet port through the common gas flow space and out the first gas outlet port,
while conditioning one of the gas streams.

42. A gas handling system, and/or a method as in any preceding claim, comprising:
flowing the first gas stream from the first gas inlet port through the common gas flow space and out the first gas outlet port and inhibiting the first gas stream from flowing from the first gas inlet port to the second gas outlet port, while flowing the second gas stream from the second gas inlet port through the common gas flow space and out the second gas outlet port and inhibiting the second gas stream from flowing from the second gas inlet port to the first gas outlet port; and
flowing the first gas stream from the first gas inlet port through the common gas flow space and out the second gas outlet port and inhibiting the first gas stream from flowing from the first gas inlet port to the first gas outlet port, while flowing the second gas stream from the second gas inlet port through the common gas flow space and out the first gas outlet port and inhibiting the second gas stream from flowing from the second gas inlet port to the second gas outlet port.

43. A gas handling system, and/or a method as in any preceding claim, wherein the first and second gas inlet ports and the first and second gas outlet ports are fluidly connected to a common gas flow space.

44. A gas handling system, and/or a method as in any one of the preceding claims, wherein the common gas flow space is reconfigurable to provide a first gas flow pathway through a first portion of the common gas flow space that fluidly connects the first gas inlet port with the first gas outlet port, while providing a second gas flow pathway through a second portion of the common gas flow space that fluidly connects the second gas inlet port with the second gas outlet port.

45. A gas handling system, and/or a method as in any preceding claim, wherein the first and second gas inlet ports together comprise a total inlet port cross-section, and the common gas flow space comprises a volume of no more than 20 times, in a given unit cubed unit, the maximum total inlet port cross-section in the same unit squared.

46. A gas handling system, and/or a method as in any preceding claim, wherein the common gas flow space comprises a volume of no more than 15, 10, or 5 times, in cubic units, the maximum total inlet port cross-section in the same unit squared.

47. A gas handling system, and/or a method as in any preceding claim, wherein at least one of the first and second gas inlet ports is configured to receive air.

48. A gas handling system, and/or a method as in any preceding claim, wherein the first and second gas inlet ports are both configured for connection to a common source of a gas.

49. A gas handling system, and/or a method as in any preceding claim, wherein the common gas source is indoor air.

50. A gas handling system, and/or a method as in any preceding claim, wherein the common gas source is outdoor air.

51. A gas handling system, and/or a method as in any preceding claim, wherein in a first configuration the first gas outlet port is connected to indoor space while the second gas outlet port is connected to outdoor space, and in a second configuration the first gas outlet port is connected to outdoor space while the second gas outlet port is connected to indoor space.

52. A gas handling system, and/or a method as in any preceding claim, wherein in a first configuration the first gas inlet port draws a gas from a space in fluid communication with the first gas outlet port, and in a second configuration the second gas inlet port draws a gas from a space in fluid communication with the first gas outlet port.

53. A gas handling system, and/or a method as in any preceding claim, wherein the gas is air.

54. A gas handling system, and/or a method as in any preceding claim, further comprising a heat pump.

55. A gas handling system, and/or a method as in any preceding claim, comprising a first heat and/or mass transfer element and a second heat and/or mass transfer element, wherein each of the first and second transfer elements is configured to function as a condenser or an evaporator.

56. A gas handling system, and/or a method as in any preceding claim, further comprising an adsorbent.

57. A gas handling system, and/or a method as in any preceding claim, wherein the adsorbent is a desiccant.

58. A gas handling system, and/or a method as in any preceding claim, comprising an adsorbent associated with each of the first and second transfer elements.

59. A gas handling system, and/or a method as in any preceding claim, further comprising a heat and/or mass transfer element associated with each of the first and second gas inlet ports.

60. A gas handling system, and/or a method as in any preceding claim, further comprising an adsorbent associated with each of the heat and/or mass transfer elements.

61. A gas handling system, and/or a method as in any preceding claim, wherein when the valve assembly is in the first configuration, and/or the common gas flow space is configured to provide a first gas flow pathway, and/or the device is in the first configuration, a first heat exchange component associated with the first gas inlet port is set as a condenser and a second heat exchange component associated with the second gas inlet port is set as an evaporator,
and when the valve assembly is in the second configuration, and/or the common gas flow space is configured to provide a second gas flow pathway, and/or the device is in the second configuration, the first heat pump associated with the first gas inlet port is set as an evaporator and the second heat pump associated with the second gas inlet port is set as a condenser.

62. A gas handling system, and/or a method as in any preceding claim, further comprising an adsorbent associated with each of the heat exchange components.

63. A gas handling system, and/or a method as in any preceding claim, wherein the first and/or second heat and/or mass transfer element is configured to be removably thermally connectable to a heat source and/or sink.

64. A gas handling system, and/or a method as in any preceding claim, wherein the adsorbent is configured to adsorb a species from the gas.

65. A gas handling system, and/or a method as in any preceding claim, wherein the adsorbent is configured to adsorb water from air.
